(19) United States
(12) Patent Application Publication
(10) Pub. No.: US 2025/0133308 A1
(43) Pub. Date: Apr. 24, 2025

(54) METHOD AND DEVICE FOR OBTAINING AN IMAGE USING A PHOTON COUNTING IMAGE SENSOR

(71) Applicant: SAMSUNG ELECTRONICS CO., LTD., Suwon-si (KR)

(72) Inventor: Jungwoo KIM, Suwon-si (KR)

(73) Assignee: SAMSUNG ELECTRONICS CO., LTD, Suwon-si (KR)

(21) Appl. No.: 18/805,166

(22) Filed: Aug. 14, 2024

(30) Foreign Application Priority Data
Oct. 18, 2023 (KR) 10-2023-0139872

(51) Int. Cl. H04N 25/773; G06T 7/11; G06T 7/80; G06V 10/60

(52) U.S. Cl. CPC H04N 25/773; G06T 7/11; G06T 7/80; G06V 10/60

(57) ABSTRACT

A method of obtaining an image includes: determining a parameter for splitting a frame into a plurality of subframes; obtaining an image signal during at least one subframe period corresponding to the determined parameter, by using a counted number of a counter provided in a pixel of a photon counting image sensor; and estimating image information of the frame based on the obtained image signal. The parameter includes a frame period, a subframe period, and a threshold value of the counter.

### CROSS-REFERENCE TO RELATED APPLICATION

This application is based on and claims priority under 35 U.S.C. § 119 to Korean Patent Application No. 10-2023-0139872, filed on Oct. 18, 2023, in the Korean Intellectual Property Office, the disclosure of which is incorporated by reference herein in its entirety.

### BACKGROUND

### 1. Field

The disclosure relates to a method and a device for obtaining an image using a photon counting image sensor.

### 2. Description of the Related Art

Image sensors are a device that converts light reflected or scattered from an object into an electrical signal. Generally, image sensors accumulate charges generated by light incident on pixels during a certain period of time and generate the electrical signal using the accumulated charges. Thus, the intensity of incident light may be expressed in a form of voltage.

In a field of imaging technology for high-speed image capturing, various types of digital pixel sensors (hereinafter referred to as DPSs) are under development. In particular, interest in the DPS, which enables high-speed image capturing even in a low illuminance environment, has increased.

Recently, as photon counting imaging technology, studies have been actively conducted into photon counting imaging technology, which measures an amount of light for each pixel by counting a number of photons incident on a pixel during a certain period of time on a time domain by using a fast photodiode, for example, a single-photon avalanche diode (SPAD), and generates a two-dimensional image based thereon.

### SUMMARY

Provided are a method and a device for obtaining an image using a photon counting image sensor. The technical problems to be solved by the disclosure are not limited to those described above, and other technical problems may be inferred from the following embodiments.

Additional aspects will be set forth in part in the description which follows and, in part, will be apparent from the description, or may be learned by practice of the presented embodiments of the disclosure.

According to an aspect of an example embodiment, provided is a method of obtaining an image, the method including: determining a parameter for splitting a frame into a plurality of subframes; obtaining an image signal during at least one subframe period corresponding to the determined parameter, by using a counted number of a counter provided in a pixel of a photon counting image sensor; and estimating image information of the frame based on the obtained image signal, wherein the parameter includes a frame period, a subframe period, and a threshold value of the counter.

The determining the parameter may include: setting an initial parameter based on an ambient illuminance obtained by an illumination sensor or previously obtained image information; and calibrating the initial parameter based on image information obtained during a subframe period corresponding to the initial parameter.

The calibrating the initial parameter may include: obtaining image information during the subframe period corresponding to the initial parameter; predicting an ambient illuminance of the photon counting image sensor based on the obtained image information; and based on the predicted ambient illuminance being greater than a preset illuminance, decreasing a length of the subframe period by a first preset length of time, and based on the predicted ambient illuminance being less than the preset illuminance, increasing the length of the subframe period by a second preset length of time.

The obtaining the image signal during the at least one subframe period may include: counting, by using the counter, a cumulative number of pulse signals generated by photons incident on the pixel during the at least one subframe period; controlling an operation of a single photon avalanche diode (SPAD) provided in the pixel according to the counted cumulative number; and obtaining an image signal based on the cumulative number counted during the operation of the SPAD.

The controlling the operation of the SPAD may include stopping the operation of the SPAD based on the counted cumulative number being greater than the threshold value.

The estimating the image information of the frame may include estimating the image information of the frame based on the image signal obtained during the at least one subframe period and a ratio of the subframe period to the frame period.

According to an aspect of an example embodiment, provided is a device for obtaining an image, the device including: a photon counting image sensor including: a pixel array including one or more pixels; and a counter provided in each of the one or more pixels and configured to count a number of pulse signals generated by photons incident on the one or more pixels; and a processor configured to: determine a parameter for splitting a frame into a plurality of subframes, wherein the parameter includes a frame period, a subframe period, and a threshold value of the counter; obtain an image signal during at least one subframe period corresponding to the determined parameter, by using the counted number of the counter; and estimate image information of the frame based on the obtained image signal.

The photon counting image sensor may further include a controller configured to set an initial parameter based on an ambient illuminance of the photon counting image sensor or previously obtained image information, and the processor may be further configured to calibrate the initial parameter based on image information obtained during a subframe period corresponding to the initial parameter.

The processor may be further configured to predict an ambient illuminance of the photon counting image sensor based on the image information obtained during the subframe period corresponding to the initial parameter, and calibrate the initial parameter based on the predicted ambient illuminance.

The processor may be further configured to decrease a length of the subframe period by a first preset length of time based on the predicted ambient illuminance being greater than a preset illuminance, and increase the length of the subframe period by a second preset length of time based on the predicted ambient illuminance being less than the preset illuminance.

The processor may be further configured to maintain the subframe period based on the predicted ambient illuminance being equal to a preset illuminance.

The photon counting image sensor may further include a control logic configured to output a signal for controlling an operation of a single photon avalanche diode (SPAD) provided in each of the one or more pixels, and the processor may be further configured to obtain an image signal based on a cumulative number, counted by the counter, of the pulse signals generated by photons incident on the one or more pixels during the operation of the SPAD.

The counter may be further configured to transmit a threshold signal to the control logic based on the counted number being greater than the threshold value, and the control logic may be further configured to output an on signal for stopping the operation of the SPAD based on the threshold signal being received at the control logic.

The processor may be further configured to transmit a reset signal to the control logic based on an elapse of the frame period, and the control logic may be further configured to output an enable signal for performing the operation of the SPAD again in a next frame based on the reset signal being received at the control logic.

The processor may be further configured to estimate the image information of the frame based on the image signal obtained during the at least one subframe period and a ratio of the subframe period to the frame period.

According to an aspect of an example embodiment, provided is a photon counting image sensor including: a pixel array including one or more pixels; a counter provided in each of the one or more pixels and configured to count a number of pulse signals generated by photons incident on the one or more pixels; and a control logic configured to output a signal for controlling an operation of a single photon avalanche diode (SPAD) provided in the one or more pixels.

The counter may be further configured to transmit a threshold signal to the control logic based on the counted number being greater than a threshold value of the counter, and the control logic may be further configured to output an on signal for stopping the operation of the SPAD based on the threshold signal being received at the control logic.

The control logic may be further configured to receive a reset signal based on an elapse of a frame period, and output an enable signal for performing the operation of the SPAD again in a next frame.

The photon counting image sensor may further include a controller configured to set an initial parameter based on an ambient illuminance of the photon counting image sensor or previously obtained image information. The initial parameter may be calibrated based on image information obtained during a subframe period corresponding to the initial parameter, and a parameter for splitting a frame into a plurality of subframes is determined based on the calibrated parameter. The calibrated parameter may include a frame period, a subframe period corresponding to the calibrated parameter, and a threshold value of the counter.

The ambient illuminance of the photon counting image sensor may be predicted based on the image information obtained during the subframe period corresponding to the initial parameter, and the subframe period corresponding to the calibrated parameter may be obtained by calibrating the subframe period corresponding to the initial parameter based on the predicted ambient illuminance and a preset illuminance.

### BRIEF DESCRIPTION OF THE DRAWINGS

The above and other aspects, features, and advantages of certain example embodiments of the disclosure will be more apparent from the following description taken in conjunction with the accompanying drawings, in which:

FIG. 1 is a block diagram of an image obtaining device according to an example embodiment;

FIG. 2 is a circuit diagram of a pixel illustrated in FIG. 1;

FIG. 3A is a diagram for describing a method of estimating image information of a frame based on an image signal of a subframe, according to an example embodiment;

FIG. 3B is a diagram for describing a method of estimating image information of a frame based on an image signal of a subframe, according to an example embodiment;

FIG. 4 is a diagram for describing an operation of a photon counting image sensor according to an example embodiment;

FIG. 5 is a block diagram of a photon counting image sensor according to an example embodiment;

FIG. 6 is a block diagram of an image obtaining device according to an example embodiment;

FIG. 7 is a flowchart for describing an image obtaining method using a photon counting image sensor according to an example embodiment;

FIG. 8 is a flowchart for describing a parameter determining method;

FIG. 9 is a block diagram illustrating a configuration of an electronic apparatus according to an example embodiment;

FIG. 10 is a block diagram of a camera module provided in the electronic apparatus of FIG. 9; and

FIGS. 11 to 20 are diagrams illustrating various examples of electronic apparatuses to which an image obtaining device according to example embodiments are applied.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As for the terms as used in the example embodiments, common terms that are currently widely used are selected as much as possible while taking into account the functions in the example embodiments. However, the terms may vary depending on the intention of those of ordinary skill in the art, precedents, the emergence of new technology, and the like. Also, in a specific case, there are also terms arbitrarily selected by the applicant. In this case, the meaning of the terms will be described in detail in the description of example embodiments of the disclosure. Therefore, the terms as used in the example embodiments should be defined based on the meaning of the terms and the description throughout the example embodiments rather than simply the names of the terms.

In the description of example embodiments, it will be understood that when a portion is referred to as being “connected to” another portion, it may be “directly connected to” the other portion or “electrically connected to” the other portion with intervening portions therebetween. The singular forms as used herein are intended to include the plural forms as well unless the context clearly indicates otherwise. It will be understood that the terms “comprise,” “include,” or “have” as used herein specify the presence of stated elements, but do not preclude the presence or addition of one or more other elements.

The terms such as “configured with” or “include” used in the example embodiments should not be construed as necessarily including all of the various components or operations described in the specification. The terms should be construed that some of the components or operations may not be included, or additional components or operations may be included.

It will be understood that although the terms “first,” “second,” etc. may be used to describe various elements, these elements should not be limited by these terms. These terms may be used to distinguish one element from another. Features that are described in one example embodiment may be present in other example embodiments.

The description of the example embodiments should not be construed as limiting the scope of the disclosure, and what may be easily inferred by those of ordinary skill in the art should be construed as falling within the scope of the example embodiments. Hereinafter, example embodiments are only for illustrative purposes and will be described in detail with reference to the accompanying drawings.

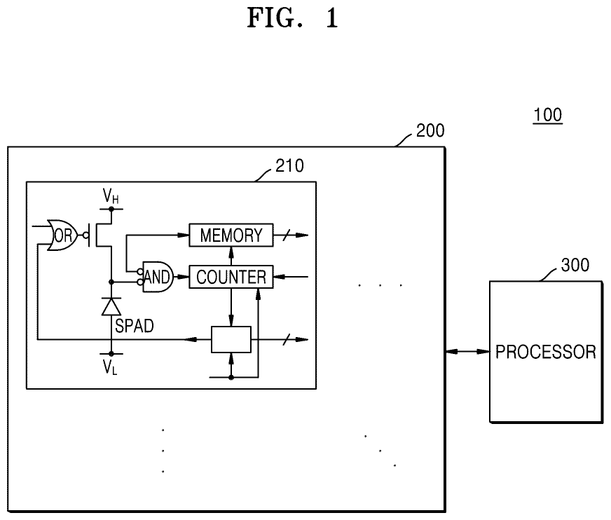

FIG. 1 is a block diagram of an image obtaining device 100 according to an example embodiment.

Referring to FIG. 1, the image obtaining device 100 according to an example embodiment may include a photon counting image sensor 200 and a processor 300.

The image obtaining device 100 may detect light reflected or scattered from an object and output an electrical signal based on the detected light. For example, the image obtaining device 100 may output a counting value based on the light reflected or scattered from the object.

The photon counting image sensor 200 may employ a single-photon avalanche diode (SPAD) or an avalanche photo diode (APD). The photon counting image sensor 200 may count a number of pulse signals generated by photons incident on a pixel 210 by using the SPAD. Hereinafter, an example of using the single-photon avalanche diode (SPAD) will be described for description purposes, however, example embodiments are not limited thereto.

The SPAD refers to a next-generation semiconductor optical device with extremely high efficiency sufficient to detect a single photon due to very high gain characteristics of the device. When a voltage higher than a breakdown voltage of the device is applied to the SPAD, free electrons (or carriers) are accelerated by a very large electric field, causing strong collisions with atoms. Accordingly, an impact ionization phenomenon occurs in which electrons bound to atoms are released and a number of free electrons rapidly increases. This is called avalanche multiplication. Due to this effect, the number of free electrons generated by photons emitted from an outside towards the image sensor greatly increases. In other words, even when an ambient environment is very dark or light is emitted from a very far-away place, and thus, only very fine photons enter the image sensor, these photons may be multiplied and recognized as if many photons have entered.

The processor 300 may control overall operations of various hardware and/or software components provided in the image obtaining device 100.

The processor 300 may split a frame into a plurality of subframes and obtain an image signal by using the plurality of subframes. All the subframes obtained by splitting the frame may have respective subframe periods having the same length. However, the disclosure is not limited thereto, and all the subframes may have subframe periods having different lengths. For example, the processor may split a frame having a total frame period of 22 ms into a total of five subframes. Among the five subframes, three subframes may each have a subframe period of 4 ms and two subframes may each have a subframe period of 5 ms.

The processor 300 may determine a frame period, a subframe period, and a threshold value for a counter included in the photon counting image sensor 200 as a parameter for splitting the frame into the subframes. The threshold value will be described in more detail later. For example, the processor 300 may determine an initial parameter by setting a length of the subframe period and then calibrating the length of the subframe period corresponding to the initial parameter based on image information of the subframe corresponding to the set initial parameter.

The processor 300 may set the initial parameter based on an ambient illuminance of the photon counting image sensor 200. For example, the ambient illuminance of the photon counting image sensor 200 may be obtained by an illumination sensor or may be obtained based on image information previously obtained by the photon counting image sensor 200.

The processor 300 may obtain an image signal based on the number of pulse signals counted by the photon counting image sensor 200. As the processor 300 obtains an image signal during each subframe period, the processor 300 may obtain an image signal during the frame period.

The processor 300 may calibrate the length of the subframe period according to the ambient illuminance of the photon counting image sensor 200.

For example, when the ambient illuminance of the photon counting image sensor 200 is very low (e.g., less than a first threshold value), the processor 300 may increase the length of the subframe period. Accordingly, as an exposure time increases, the image obtaining device 100, to which the photon counting image sensor 200 is applied, may implement a high dynamic range (hereinafter referred to as HDR). Herein, the HDR may refer to comprehensive technology for implementing an image that maximizes a difference between a bright part and a dark part in an image.

For example, when the ambient illuminance of the photon counting image sensor 200 is high (e.g., higher than a second threshold value, which is higher than the first threshold value), the processor 300 may decrease the length of the subframe period. Accordingly, even when the number of photons incident during the frame period increases, the number of photons incident during the subframe period decreases. Therefore, the image obtaining device 100, to which the photon counting image sensor 200 is applied, may prevent an overflow state of a counter for counting the number of pulse signals generated by photons incident on the pixel 210.

The image obtaining device 100 may further include a memory in which programs and/or data for operations to be performed by the processor 300 are stored. The memory may be a hardware that stores various data processed in the image obtaining device 100. For example, the memory may store data processed by the image obtaining device 100 and data to be processed by the image obtaining device 100. In addition, the memory may store applications, drivers, etc. to be driven in the image obtaining device 100. The memory may include a random access memory (RAM) (e.g., a dynamic random access memory (DRAM), a static random access memory (SRAM), etc.), a read-only memory (ROM), an electrically erasable programmable read-only memory (EEPROM), a compact-disc read-only memory (CD-ROM), a Blu-ray or other optical disk storage, a hard disk drive (HDD), a solid state drive (SSD), or a flash memory. Furthermore, the memory may include other external storage devices that are accessible to the image obtaining device 100.

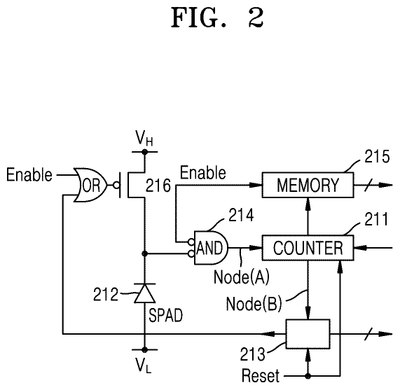

FIG. 2 is a circuit diagram of the pixel 210 illustrated in FIG. 1.

Referring to FIG. 2, the pixel 210 may include a counter 211, an SPAD 212, and a control logic 213. The elements and/or integrated circuits included in the pixel 210 are not limited to the elements and/or integrated circuits illustrated in FIG. 2. The elements and/or integrated circuits included in the pixel 210 illustrated in FIG. 2 may be replaced with other elements and/or other integrated circuits, and additional elements or additional integrated circuits may be added thereto.

The counter 211 may count the number of pulse signals generated from the SPAD 212 by photons incident on the pixel 210 during a certain period of time. A processor (e.g., the processor 300 of FIG. 1) may obtain an image signal based on the number of pulse signals counted during the certain period of time. The processor may obtain image information during the certain period of time based on the obtained image signal. For example, the counter 211 may count the number of pulse signals generated from the SPAD 212 during a frame period, and the processor may obtain image information of a frame based on the counted number.

The number of photons incident on the pixel 210 may change according to the ambient illuminance of the photon counting image sensor.

In a low illuminance environment, a very small number of photons may be incident on the pixel 210. Herein, the expression “low illuminance” may be an expression to refer to a very dark environment (e.g., having an illuminance less than a certain threshold) or an environment in which light is emitted from a very far-away place (e.g., having a distance greater than a certain threshold from the photon counting image sensor). Hereinafter, these expressions may be interchangeably used with the same or similar meaning. Because a pulse signal may be generated from the SPAD 212 by avalanche magnification even in a low illuminance environment, the counter 211 may count the number of pulse signals generated from the SPAD 212. Even in a low illuminance environment, the processor may obtain image information of a frame based on the number of pulse signals counted by the counter 211.

In a high illuminance environment, a very large number of photons may be incident on the pixel 210. Herein, the expression “high illuminance” may be an expression to refer to a very bright environment (e.g., having an illuminance greater than a certain threshold) or an environment in which light is emitted from a very close place (e.g., having a distance less than a certain threshold from the photon counting image sensor). Hereinafter, these expressions may be interchangeably used with the same or similar meaning. In a high illuminance environment, an overflow may occur in the counter 211 due to avalanche magnification. When the number of photons incident on the pixel 210 is greater than a size of the counter 211, the counter 211 may not accurately count the number of pulse signals generated from the SPAD 212. As the number of photons incident on the pixel 210 increases in a high illuminance environment, the size of the counter 211 needs to increase. However, as the size of the counter 211 increases, an amount of power consumption may also increase.

Accordingly, the size of the counter 211 may be determined by taking into account both the ambient illuminance of the photon counting image sensor and an amount of power consumed by the photon counting image sensor. For example, the size of the counter 211 may be about 8 bits to about 12 bits. In an example embodiment, the size of the counter 211 may be about 10 bits. However, the size of the counter 211 is not limited thereto, and may be variously implemented according to the size of the pixel 210 and/or various embodiments of the image obtaining device to which the photon counting image sensor is applied.

As an example, by splitting a frame into a plurality of subframes, the occurrence of an overflow in the counter 211 may be prevented even while the size of the counter 211 is maintained. As another example, when the threshold value of the counter 211 is set by taking into account the size of the counter 211 and the counted number of pulse signals is greater than the threshold value, the operation of the SPAD 212 is stopped to prevent an overflow from occurring in the counter 211.

Herein, the expression “threshold value” may be an expression to refer to a number of pulse signals counted immediately before an overflow occurs in the counter or a value determined based thereon. Hereinafter, these expressions may be interchangeably used with the same or similar meaning. For example, the threshold value may be set to a fixed value according to specifications of the counter 211, such as the size of the counter 211, but the disclosure is not limited thereto. As another example, the threshold value may be set to a value that may be varied by an external input.

An anode electrode of the SPAD 212 may be connected to a low level (e.g., V_{L}). An AND logic circuit 214 may be between a cathode electrode of the SPAD 212 and the counter 211. A signal output from the AND logic circuit 214 connected to the SPAD 212 may be output from the counter 211 to an outside through a memory 215. The memory 215 may store a cumulative number of pulse signals counted by the counter 211 and the data stored in the memory 215 may be output to the outside.

The control logic 213 may output a signal for controlling the operation of the SPAD 212. For example, the control logic 213 may output an on signal for stopping the operation of the SPAD 212. When the on signal output by the control logic 213 has a high level, a transistor that supplies power to the SPAD 212 may be turned off, and thus, the operation of the SPAD 212 may be stopped. When the on signal output by the control logic 213 has a low level, the transistor that supplies power to the SPAD 212 may be turned on, and thus, the operation of the SPAD 212 may be performed.

An image obtaining device (e.g., the image obtaining device 100 of FIG. 1) including the control logic 213 may control the SPAD 212 to operate only during one frame period or a portion of subframe periods of a plurality of subframes into which a frame is split. Accordingly, the counter 211 may count the number of pulse signals generated from the SPAD 212 while the operation of the SPAD 212 is performed, and the processor may generate an image signal during the period in which the operation of the SPAD 212 is performed, based on the counted number.

For example, the counter 211 may be configured to transmit a threshold signal to the control logic 213 when the counted number is greater than the threshold value, and the control logic 213 having received the threshold signal may output an on signal for stopping the operation of the SPAD 212. The on signal output by the control logic 213 may be set to a high level, the transistor that supplies power to the SPAD 212 may be turned off, and thus, the operation of the SPAD 212 may be stopped.

As another example, when the control logic 213 receives a reset signal from the processor, the on signal output by the control logic 213 may be set to change to a low level. Accordingly, the transistor that supplies power to the SPAD 212 may be turned on and the operation of the SPAD 212 may be performed. The processor may be configured to transmit the reset signal to the control logic 213 when one frame period has elapsed. The control logic 213 having received the reset signal may output an enable signal for performing the operation of the SPAD 212 again, and accordingly, the operation of the SPAD 212 may be performed again.

The image obtaining device including the control logic 213 may prevent an overflow from occurring in the counter 211 while the size of the counter 211 is maintained. Accordingly, the image obtaining device including the control logic 213 may not require an additional configuration for obtaining information about the counted number, and the power consumption of the image obtaining device may be reduced (or may not be increased).

The pixel may further include a quenching circuit 216. Although FIG. 2 illustrates that the quenching circuit 216 and the AND logic circuit 214 are separate elements, the disclosure is not limited thereto. As another example, the quenching circuit 216 may include the AND logic circuit 214.

The quenching circuit 216 may be between the cathode electrode of the SPAD 212 and a high level (e.g., V_{H}). The quenching circuit 216 may limit an excess current that may be generated from the SPAD 212 due to avalanche magnification. As a reverse voltage applied to the SPAD 212 increases, a probability that electrons will be in an excited state and a tunneling will occur in the SPAD 212 may increase. Accordingly, avalanche magnification may occur even when there are no incident photons, and thus, the generated dark current may increase. The quenching circuit 216 may suppress a flow of an excess current that may be generated due to avalanche magnification by suppressing the voltage applied to the SPAD 212.

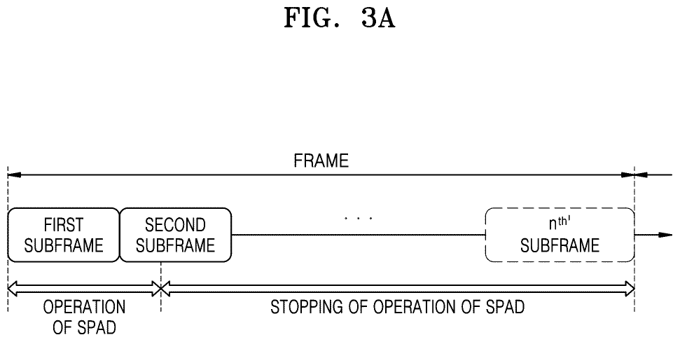

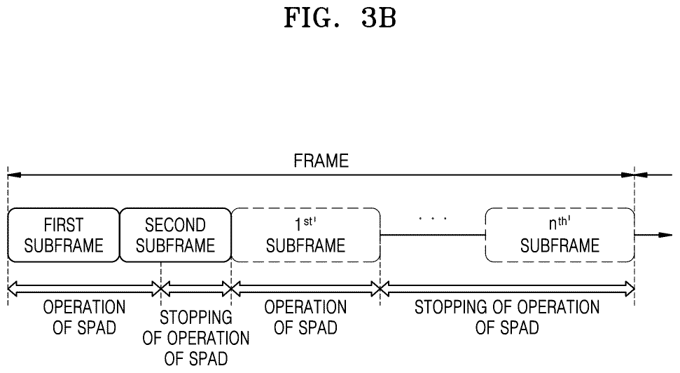

Hereinafter, a case where the image obtaining device using the photon counting image sensor including the pixel 210 of FIG. 2 estimates image information of a frame will be described with reference to FIGS. 3A and 3B.

FIG. 3A is a diagram for describing a method of estimating image information of a frame based on an image signal of a subframe, according to an example embodiment, and FIG. 3B is a diagram for describing a method of estimating image information of a frame based on an image signal of a subframe, according to another example embodiment. Hereinafter, the method of estimating the image information of the frame in FIGS. 3A and 3B will be described with reference to the elements and/or integrated circuits of the image obtaining device 100 and/or the photon counting image sensor 200 illustrated in FIGS. 1 and 2.

Referring to FIG. 3A, it one frame may be split into n subframes, including a first subframe to an nth subframe, an operation of the SPAD (e.g., the SPAD 212 of FIG. 2) may be performed during an entire period of the first subframe and a partial period of a second subframe, and the operation of the SPAD may be stopped during a remaining period of the second subframe and an entire period of a third subframe to an entire period of the n^{th} subframe.

When the number of pulse signals counted by the counter (e.g., the counter 211 of FIG. 2) during the first subframe period is not greater than the threshold value, the operation of the SPAD (e.g., the SPAD 212 of FIG. 2) may not stop even after the first subframe period has elapsed, and the counter may continue to count the cumulative number of pulse signals. When the cumulative number of pulse signals counted by the counter becomes greater than the threshold value during the second subframe period, the operation of the SPAD may be stopped (e.g., before an entire period of the second subframe period elapses). That is, the counter may count the number of pulse signals generated during a period in which the operation of the SPAD is performed, that is, during the first subframe period and the partial period of the second subframe period.

The processor may obtain an image signal during the period in which the operation of the SPAD is performed, based on the number of pulse signals counted during the period in which the operation of the SPAD is performed, and the processor may obtain image information during the period in which the operation of the SPAD is performed, based on the obtained image signal. That is, the processor may estimate the image information of a frame based on the image information of the period in which the operation of the SPAD is performed, the period in which the operation of the SPAD is performed, and the frame period. For example, the processor may estimate the image information of the frame based on the obtained image information of the period in which the operation of the SPAD is performed and a ratio of the period in which the operation of the SPAD is performed to the frame period.

According to an example embodiment, while the operation of the SPAD may not be performed after the entire period of the first subframe and the partial period of the second subframe have elapsed, the image obtaining device may estimate the image information of the frame. Accordingly, the power consumption of the image obtaining device may be greatly reduced.

Referring to FIG. 3B, one frame may be split into a first subframe, a second subframe, 1^{st}′ subframe to an n^{th}′ subframe, the operation of the SPAD may be performed during an entire period of the first subframe, a partial period of the second subframe, and an entire period of the 1^{st}′ subframe, and the operation of the SPAD may be stopped during a remaining period of the second subframe and an entire period of a 2^{nd}′ subframe to an entire period of the n^{th}′ subframe. In addition, a length of the first subframe period may be equal to a length of the second subframe period, but is different from a length of each of the 1^{st}′ subframe period to the n^{th}′ subframe period.

When the cumulative number of pulse signals counted by the counter during the first subframe period is not greater than the threshold value, the operation of the SPAD may not be stopped even after the first subframe period has elapsed, and when the cumulative number of pulse signals counted by the counter during the second subframe period reaches the threshold value, the operation of the SPAD may be stopped at the same time as the cumulative number of pulse signals counted during the second subframe period becomes greater than the threshold value (or in response to this event occurring). That is, an overflow in the counter may not occur during the period in which the operation of the SPAD is performed.

The processor may determine, as the 1^{st}′ subframe period, a period in which the operation of the SPAD is to be performed, such that an overflow may not occur in the counter during the 1^{st}′ subframe period. The 1^{st}′ subframe period may correspond to a length of time obtained by increasing the first subframe period by a certain length of time. The certain length of time may be a length of a partial period of the second subframe until the counted number of pulse signals reaches the threshold value from a time point at which the second subframe begins. In other words, the 1^{st}′ subframe period may have a length of time corresponding to a length of time from a time point at which the first subframe begins to a time point at which the partial period of the second subframe ends (or the period in which the operation of the SPAD is performed during the first subframe and the second subframe).

The operation of the SPAD may be performed again during the determined 1^{st}′ subframe period. The counter may count the number of pulse signals generated during the 1^{st}′ subframe period, and the processor may obtain an image signal during the 1^{st}′ subframe period based on the counted number. For example, the counter may count the number of pulse signals anew during the 1^{st}′ subframe period. For example, the processor may predict image information of the frame based on the image signal obtained during the 1^{st}′ subframe period. As another example, the processor may predict a total number of pulse signals generated during the frame period based on the number of pulse signals counted during the 1^{st}′ subframe period, and may predict Image information of the frame based on the predicted total number of pulse signals.

That is, the processor may estimate the image information of the frame based on the obtained image information of the 1^{st}′ subframe, the frame period, and the 1^{st}′ subframe period. For example, the processor may estimate the image information of the frame based on the obtained image information of the 1^{st}′ subframe and a ratio of the 1^{st}′ subframe period to the frame period.

Although the operation of the SPAD may not be performed during the 2^{nd}′ to the n^{th}′ subframe periods after the 1^{st}′ subframe period has elapsed, the image obtaining device may estimate the image information of the frame. Accordingly, the power consumption of the image obtaining device may be greatly reduced.

In another example embodiment, when the number of pulse signals counted by the counter reaches the threshold value during the first subframe period, the operation of the SPAD may be stopped at the same time when the number of pulse signals counted during the first subframe period becomes greater than the threshold value (or in response to this event occurring). The processor may determine, as the 1^{st}′ subframe period, the period in which the operation of the SPAD is to be performed, and the 1^{st}′ subframe period may have a length of time obtained by reducing the first subframe period by a certain length of time. The certain length of time may be a length of time from a time point at which the counted number of pulse signals becomes greater than the threshold value to a time point at which the first subframe period has elapsed.

The operation of the SPAD may be performed again during the determined 1^{st}′ subframe period, and the processor may obtain an image signal of the 1^{st}′ subframe period based on the number of pulse signals counted by the counter during the 1^{st}′ subframe period. For example, the processor may predict image information of the frame based on the image signal obtained during the 1^{st}′ subframe period. As another example, the processor may predict the total number of pulse signals generated during the frame period based on the number of pulse signals counted during the 1^{st}′ subframe period, and may predict Image information of the frame based on the predicted total number of pulse signals.

That is, the processor may estimate the image information of the frame based on the obtained image information of the 1^{st}′ subframe, the frame period, and the 1^{st}′ subframe period. For example, the processor may estimate the image information of the frame based on the obtained image information of the 1^{st}′ subframe and the ratio of the 1^{st}′ subframe period to the frame period.

Although the operation of the SPAD may not be performed during the 2^{nd}′ to the n^{th}′ subframe periods after the 1^{st}′ subframe period has elapsed, the image obtaining device may estimate the image information of the frame. Accordingly, the power consumption of the image obtaining device may be greatly reduced.

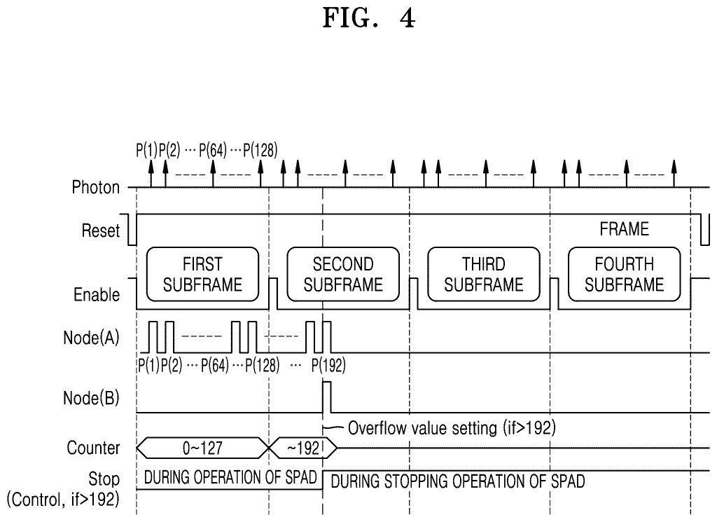

Hereinafter, signals generated in the circuit diagram of FIG. 2 during the first and second subframe periods of FIGS. 3A and 3B will be described through illustrative examples with reference to FIG. 4.

FIG. 4 is a diagram for describing the operation of the photon counting image sensor 200 according to an example embodiment. Hereinafter, the embodiment of FIG. 4 will be described with reference to the elements and/or integrated circuits of the image obtaining device 100 and/or the photon counting image sensor 200 described with reference to FIGS. 1 and 3.

Referring to FIG. 4, the processor (e.g., the processor 300 of FIG. 1) may split one frame into four subframes, the operation of the SPAD (e.g., the SPAD 212 of FIG. 2) may be performed during an entire period of the first subframe and a partial period of the second subframe, and the operation of the SPAD may be stopped during a remaining period of the second subframe, an entire period of the third subframe, and an entire period of the fourth subframe.

The processor may set an initial parameter based on an ambient illuminance of the photon counting image sensor (e.g., the photon counting image sensor 200 of FIG. 1). For example, the processor sets the frame period to 16.4 ms, the subframe period to 4.1 ms, and the threshold value to 192.

Because the number of pulse signals counted by the counter (e.g., the counter 211 of FIG. 2) during the first subframe period is 128, the operation of the SPAD is not stopped even after the first subframe period elapses. The counter counts the cumulative number of pulse signals, and the operation of the SPAD may be stopped when the number of pulse signals counted by the counter reaches the threshold value of 193 during the second subframe period.

Photons P(1) to P(128) are incident on a pixel (e.g., the pixel 210 of FIG. 1) during the first subframe period. Referring to a signal generated at node A (e.g., node (A) in FIG. 2), a pulse signal may be generated from the SPAD whenever the photons P(1) to P(128) are incident on the pixel. Node A refers to a point between a logic circuit connected to the SPAD (e.g., the AND logic circuit 214 of FIG. 2) and the counter. The pulse signal generated from the SPAD may be output from the logic circuit connected to the SPAD and output from the counter through the memory to the outside. The counter counts the number of pulse signals output from the logic circuit connected to the SPAD. The number of pulse signals counted by the counter during the first subframe period may be 128, and the counter may continue to count the cumulative number of pulse signals during the second subframe period. When the cumulative number of pulse signals counted by the counter during the second subframe period reaches 193, the counter may transmit the threshold signal to the control logic (e.g., the control logic 213 of FIG. 2). Referring to the signal generated at node B (e.g., node (B) in FIG. 2), the control logic having received the threshold signal may output an on signal for stopping the operation of the SPAD. As the on signal is output, the operation of the SPAD may be stopped. Node B refers to a point between the counter and the control logic. When the operation of the SPAD is stopped, even when photons are incident on the pixel, no pulse signal is generated from the SPAD. When the frame period has elapsed, the control logic may receive a reset signal from the processor and output an enable signal for performing the operation of the SPAD again. As new photons are incident on the pixel during a new frame period, the process described above is repeated again.

The processor may estimate the image information of the frame based on the image signal obtained by using the counted number of pulse signals, the frame period, and the subframe period.

According to one example, the processor may estimate a photon intensity of the frame as 512 by using that the number of pulse signals obtained during the first subframe period is 128 and the number of subframes is 4. Accordingly, the processor may estimate the image information of the frame.

According to another example, the processor may estimate that the period in which the SPAD operates is 6.15 ms by using that the number of pulse signals obtained during the entire period (e.g., 4.1 ms) of the first subframe is 128 and the number of pulse signals obtained during the partial period (e.g., 2.05 ms) of the second subframe is 64. The processor may calibrate the length of the subframe period, which is 4.1 ms. The processor may determine the 1^{st}′ subframe period to be 6.15 ms by increasing the subframe period by a length of time of 2.05 ms. The processor may estimate the image information of the frame based on the number of pulse signals obtained during the determined 1^{st}′ subframe period.

According to another example, the processor may predict the ambient illuminance of the photon image sensor for calibrating the first subframe period based on the fact that the number of pulse signals obtained during the first subframe period is 128. When the predicted ambient illuminance is greater than a first preset illuminance, the processor may decrease the first subframe period by a certain length of time. When the predicted ambient illuminance is less than a second preset illuminance, the processor may increase the first subframe period by a certain length of time. The first preset illuminance and the second preset illuminance may be the same or different. Hereinafter, for illustrative purposes, an example embodiment in which the same preset illuminance is used will be described, however, example embodiments are not limited thereto. The processor may obtain the image signal of the 1^{st}′ subframe by re-obtaining the number of pulse signals during the calibrated 1^{st}′ subframe period, and may estimate the image information of the frame based on the obtained image signal of the 1^{st}′ subframe.

However, the method by which the processor estimates the image information of the frame is not limited thereto and may be implemented in various ways according to various embodiments of the image obtaining device to which the photon counting image sensor is applied.

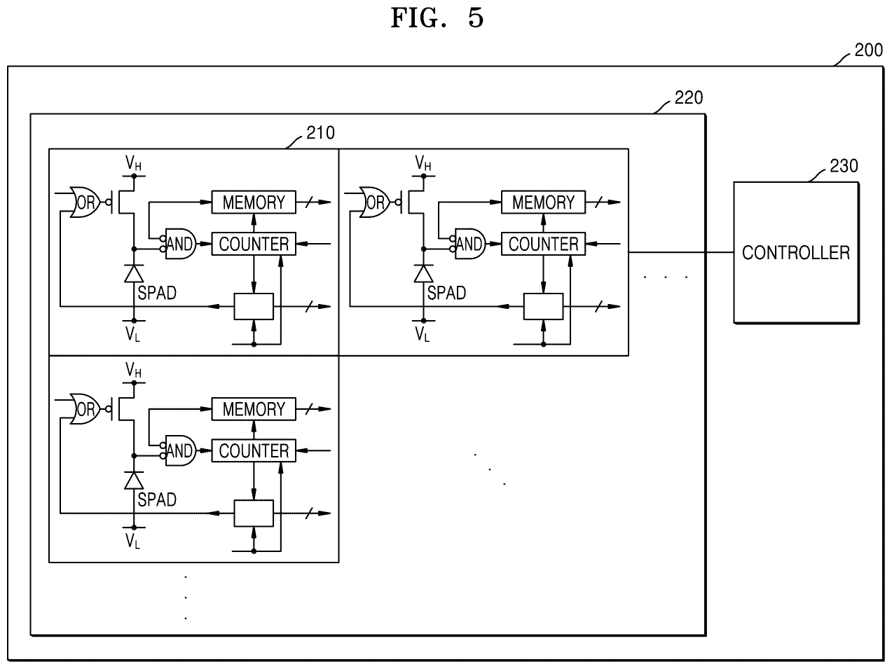

FIG. 5 is a block diagram of a photon counting image sensor 200 according to another example embodiment.

Referring to FIG. 5, the photon counting image sensor 200 according to another example embodiment may include a pixel 210, a pixel array 220, and a controller 230. At least some of the elements of the photon counting image sensor 200 of FIG. 4 may be identical to or similar to the elements of the photon counting image sensor 200 of FIG. 1, and at least some of the elements and integrated circuits of the pixel 210 of FIG. 5 may be identical to or similar to at least some of the elements and integrated circuits of the pixel 210 of FIG. 2.

The pixel 210 may include a counter (e.g., the counter 211 of FIG. 2), an SPAD (e.g., the SPAD 212 of FIG. 2), and a control logic (e.g., the control logic 213 of FIG. 2).

The counter 211 may output a counting value obtained by counting the number of pulse signals generated from the SPAD 212 by photons incident on the pixel 210 during a certain period of time. A processor (e.g., the processor 300 of FIG. 1) may obtain an image signal based on the number of pulse signals counted during the certain period of time. The processor may obtain image information during the certain period of time based on the obtained image signal. For example, the counter 211 may output a counting value obtained by counting the number of pulse signals generated from the SPAD 212 during a frame period, and the processor may obtain image information of a frame based on the counted number.

The SPAD refers to a next-generation semiconductor optical device with extremely high efficiency sufficient to detect a single photon due to very high gain characteristics of the device. When a voltage higher than a breakdown voltage of the device is applied to the SPAD, free electrons (or carriers) are accelerated by a very large electric field, causing strong collisions with atoms. Accordingly, an impact ionization phenomenon occurs in which electrons bound to atoms are released and a number of free electrons rapidly increases. This is called avalanche multiplication. Due to this effect, the number of free electrons generated by photons emitted from an outside towards the image sensor greatly increases. In other words, even when an ambient environment is very dark or light is emitted from a very far-away place, and thus, only very fine photons enter the image sensor, these photons may be multiplied and recognized as if many photons have entered.

The control logic 213 may output a signal for controlling the operation of the SPAD 212. For example, the control logic 213 may output an on signal for stopping the operation of the SPAD 212. When the on signal output by the control logic 213 has a high level, a transistor that supplies power to the SPAD 212 may be turned off, and thus, the operation of the SPAD 212 may be stopped. When the on signal output by the control logic 213 has a low level, the transistor that supplies power to the SPAD 212 may be turned on, and thus, the operation of the SPAD 212 may be performed.

The controller 230 may determine a parameter for splitting a frame into a plurality of subframes. The parameter may include a frame period, a subframe period, and a threshold value of the counter (e.g., the counter 211 of FIG. 2).

First, the controller 230 may set an initial parameter. The initial parameter may be set based on the ambient illuminance of the photon counting image sensor 200. Herein, the expression “the ambient illuminance of the photon counting image sensor 200 for setting the initial parameter” may refer to the ambient illuminance of the photon counting image sensor 200 before image information of one frame is obtained or estimated. Hereinafter, this expression may be used with the same or similar meaning as the expression “initial ambient illuminance.”

For example, the initial ambient illuminance may be obtained by an illumination sensor, but the disclosure is not limited thereto. As another example, the initial ambient illuminance may be obtained based on image information previously obtained by the image obtaining device including the photon counting image sensor 200 (e.g., the image obtaining device 100 of FIG. 1).

Next, the controller 230 may calibrate the subframe period of the set initial parameter based on the ambient illuminance of the photon counting image sensor 200. The ambient illuminance for calibrating the subframe period may be predicted based on image information obtained during the subframe period corresponding to the set initial parameter.

The image obtaining device 100 may obtain image information during the subframe period corresponding to the set initial parameter, and the image obtaining device 100 may predict (or estimate) ambient illuminance for calibrating the subframe period based on the obtained image information. When the ambient illuminance predicted as a high illuminance by the image obtaining device 100 (that is, the predicted ambient illuminance is greater than the preset illuminance), the controller 230 may decrease the length of the subframe period. Accordingly, even when the number of photons incident during the frame period increases, the number of photons incident during the subframe period decreases. Accordingly, the image obtaining device 100 may prevent an overflow in the counter. The length of the subframe period may decrease by a first preset length of time.

The first preset length of time may be set to a predetermined value or may be set to a value determined in accordance with a predetermined calculation rule. However, the disclosure is not limited thereto, and the first preset length of time may be determined in various ways according to various embodiments of the image obtaining device 100 to which the photon counting image sensor 200 is applied.

When the predicted ambient illuminance is less than the preset illuminance, the controller 230 may increase the length of the subframe period. Accordingly, as an exposure time increases, the image obtaining device 100 may implement an HDR. The length of the subframe period may increase by a second preset length of time.

The second preset length of time may be set to a predetermined value or may be set to a value determined in accordance with a predetermined calculation rule. However, the disclosure is not limited thereto, and the second preset length of time may be determined in various ways according to various embodiments of the image obtaining device 100 to which the photon counting image sensor 200 is applied.

When the predicted ambient illuminance is equal to the preset illuminance, the controller 230 may maintain the length of the subframe period corresponding to the initial parameter during the frame period.

The controller 230 may determine a parameter for splitting a frame into a plurality of subframes by setting the initial parameter and calibrating the set initial parameter. The calibrated parameter may include an increased or decreased length of the subframe period and the frame (or a portion of the frame) may be split into a plurality of subframes corresponding to the calibrated parameter.

The image obtaining device 100 may obtain an image signal during the subframe period corresponding to the determined parameter. The image obtaining device 100 may estimate image information of the frame based on the image signal obtained during the subframe period, the frame period, and the subframe period. Because the image obtaining device 100 may estimate the image information of the frame even when the image obtaining device 100 does not perform the operation of the SPAD until a new frame begins after the subframe period corresponding to the determined parameter has elapsed, the power consumption of the image obtaining device 100 may be reduced.

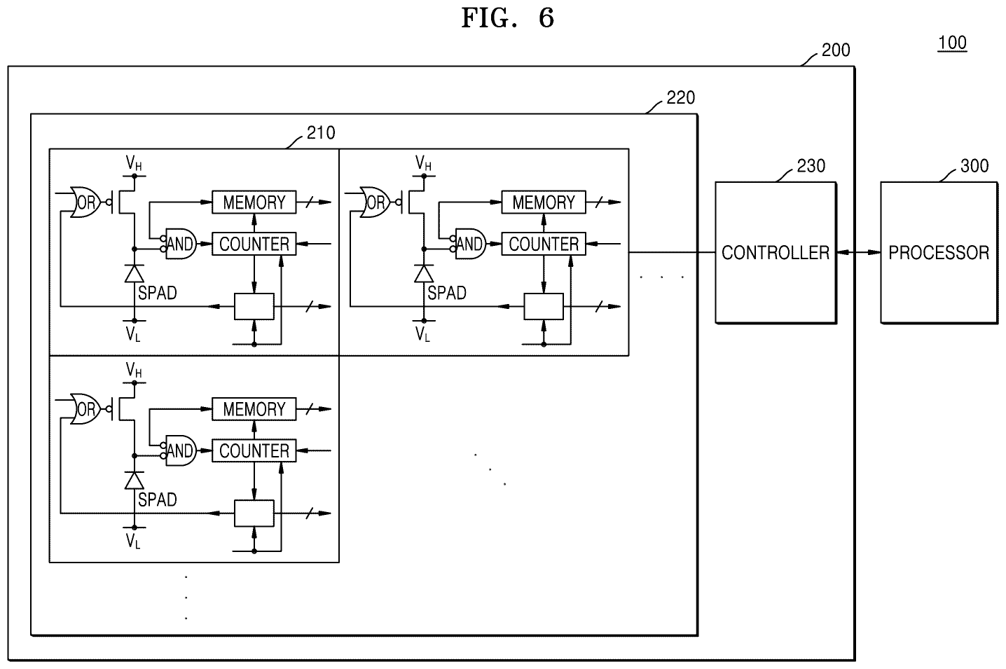

FIG. 6 is a block diagram of an image obtaining device 100 according to another example embodiment.

Referring to FIG. 6, the image obtaining device 100 according to another example embodiment may include a photon counting image sensor 200 and a processor 300. The image obtaining device 100 of FIG. 6 is an image obtaining device 100 in which the processor 300 is added to the photon counting image sensor 200 of FIG. 5. Redundant descriptions are omitted below.

According to one example, on behalf of the controller 230, the processor 300 may perform all operations performed by the controller 230 of FIG. 5.

The processor 300 may determine a parameter for splitting a frame into a plurality of subframes. The parameter may include a frame period, a subframe period, and a threshold value of the counter (e.g., the counter 211 of FIG. 2).

First, the processor 300 may set an initial parameter. The initial parameter may be set based on the ambient illuminance of the photon counting image sensor 200. For example, the initial ambient illuminance may be obtained by an illumination sensor, but the disclosure is not limited thereto. As another example, the initial ambient illuminance may be obtained based on image information previously obtained by the image obtaining device including the photon counting image sensor 200.

Next, the processor 300 may calibrate the subframe period of the set initial parameter based on the ambient illuminance of the photon counting image sensor 200. The ambient illuminance for calibrating the subframe period may be predicted based on image information obtained during the subframe period corresponding to the set initial parameter.

The processor 300 may obtain image information during the subframe period corresponding to the set initial parameter, and the processor 300 may predict (or estimate) ambient illuminance for calibrating the subframe period based on the obtained image information.

When the predicted ambient illuminance is greater than the preset illuminance, the processor 300 may decrease the length of the subframe period. Accordingly, even when the number of photons incident during the frame period increases, the number of photons incident during the subframe period may decrease. Accordingly, the image obtaining device 100 may prevent an overflow in the counter. The length of the subframe period may decrease by a first preset length of time. When the predicted ambient illuminance is less than the preset illuminance, the processor 300 may increase the length of the subframe period. Accordingly, as an exposure time increases, the image obtaining device 100 may implement an HDR. The length of the subframe period may increase by a second preset length of time. When the predicted ambient illuminance is equal to the preset illuminance, the processor 300 may maintain the length of the subframe period corresponding to the initial parameter during the frame period.

The first preset length of time and the second preset length of time may be set to the same value that may be arbitrarily determined, but the disclosure is not limited thereto. The first preset length of time and the second preset length of time may be variously implemented according to various embodiments of the image obtaining device 100 to which the photon counting image sensor 200 is applied.

The processor 300 may determine a parameter for splitting a frame into a plurality of subframes by setting an initial parameter and calibrating the set initial parameter.

The processor 300 may obtain an image signal during one or more subframe periods corresponding to the determined parameter, during which an operation of the SPAD is performed. The processor 300 may estimate image information of the frame based on the image signal obtained during the one or more subframe periods, the frame period, and the subframe period. For example, the processor 300 may estimate the image information of the frame based on the image signal acquired during the first sub-frame period corresponding to the initial parameter and the image signal acquired during the second sub-frame period corresponding to the determined parameter. Alternatively, the processor 300 may estimate the image information of the frame based on the image signal acquired during the second sub-frame period corresponding to the determined parameter. Because the image obtaining device 100 may estimate the image information of the frame even when the image obtaining device 100 does not perform the operation of the SPAD until a new frame begins after the one or more subframe periods have elapsed, the power consumption of the image obtaining device 100 may be reduced.

According to another example, on behalf of the controller 230, the processor 300 may perform a portion of the operation performed by the controller 230 of FIG. 5.

The processor 300 may determine a parameter for splitting a frame into a plurality of subframes. The parameter may include a frame period, a subframe period, and a threshold value of the counter (e.g., the counter 211 of FIG. 2).

First, the controller 230 may set an initial parameter. The initial parameter may be set based on the ambient illuminance of the photon counting image sensor 200. For example, the initial ambient illuminance may be obtained by an illumination sensor, but the disclosure is not limited thereto. As another example, the initial ambient illuminance may be obtained based on image information previously obtained by the image obtaining device including the photon counting image sensor 200.

Next, the processor 300 may calibrate the subframe period among the set initial parameter based on the ambient illuminance of the photon counting image sensor 200. The ambient illuminance for calibrating the subframe period may be predicted based on image information obtained during the subframe period corresponding to the set initial parameter.

The processor 300 may obtain image information during the subframe period corresponding to the set initial parameter, and the processor 300 may predict ambient illuminance for calibrating the subframe period based on the obtained image information.

When the predicted ambient illuminance is greater than the preset illuminance, the processor 300 may decrease the length of the subframe period. Accordingly, even when the number of photons incident during the frame period increases, the number of photons incident during the subframe period may decrease. Accordingly, the image obtaining device 100 may prevent an overflow in the counter. The length of the subframe period may decrease by a first preset length of time. When the predicted ambient illuminance is less than the preset illuminance, the processor 300 may increase the length of the subframe period. Accordingly, as an exposure time increases, the image obtaining device 100 may implement an HDR. The length of the subframe period may increase by a second preset length of time. When the predicted ambient illuminance is equal to the preset illuminance, the processor 300 may maintain the length of the subframe period corresponding to the initial parameter during the frame period.

The preset illuminance may be a value that may be variably set by an external input. However, the disclosure is not limited thereto. As another example, the preset illuminance may be determined based on a ratio of a number of pixels 210 in which an overflow has occurred to a total number of pixels 210 included in the photon counting image sensor 200.

For example, the first preset length of time and the second preset length of time may be set to the same value that may be arbitrarily determined, but the disclosure is not limited thereto. The first preset length of time and the second preset length of time may be variously implemented according to various embodiments of the image obtaining device 100 to which the photon counting image sensor 200 is applied.

The controller 230 may determine a parameter for splitting a frame into a plurality subframes by calibrating the initial parameter previously set by the controller 230. The calibrated parameter may include an increased or decreased length of the subframe period and the frame (or a portion of the frame) may be split into a plurality of subframes corresponding to the calibrated parameter.

The processor 300 may obtain an image signal during one or more subframe periods corresponding to the determined parameter, during when an operation the SPAD is performed. The processor 300 may estimate image information of the frame based on the image signal obtained during the one or more subframe periods, the frame period, and the subframe period. For example, the processor 300 may estimate the image information of the frame based on the image signal acquired during the first sub-frame period corresponding to the initial parameter and the image signal acquired during the second sub-frame period corresponding to the determined parameter. Alternatively, the processor 300 may estimate the image information of the frame based on the image signal acquired during the second sub-frame period corresponding to the determined parameter. Because the image obtaining device 100 may estimate the image information of the frame even when the image obtaining device 100 does not perform the operation of the SPAD until a new frame begins after the one or more subframe periods have elapsed, the power consumption of the image obtaining device 100 may be reduced.

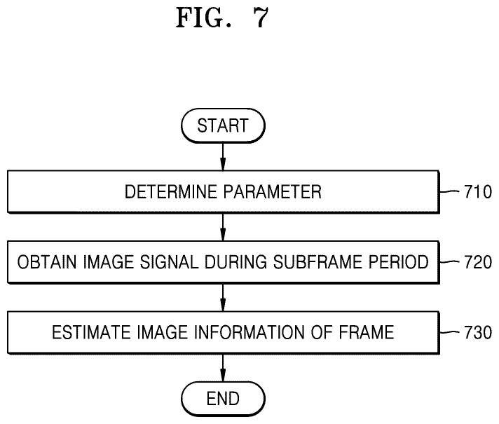

FIG. 7 is a flowchart for describing an image obtaining method using the photon counting image sensor 200 according to an example embodiment.

Referring to FIG. 7, the image obtaining method using the photon counting image sensor includes operations processed by the photon counting image sensor 200 and the image obtaining device 100 including the photon counting image sensor 200, which have been described with reference to FIGS. 1 to 6. Accordingly, the description of the photon counting image sensor 200 and the image obtaining device 100 including the photon counting image sensor 200, which have been described with reference to FIGS. 1 to 6, may be applied to the image obtaining method of FIG. 7 using the photon counting image sensor.

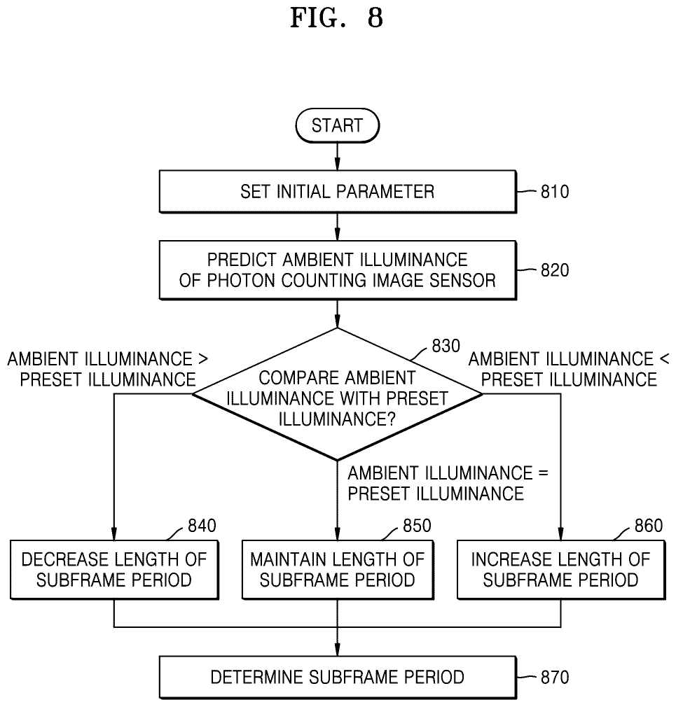

According to an example embodiment, the image obtaining method using the photon counting image sensor may be started by determining a parameter for splitting a frame into a plurality of subframes in operation 710. The parameter may include a frame period, a subframe period, and a threshold value of the counter 211. The parameter may be determined by setting an initial parameter and calibrating the set initial parameter by using the photon counting image sensor 200. A detailed description thereof is provided below with reference to FIG. 8.

In operation 720, the processor 300 may obtain an image signal during a subframe period corresponding to the determined parameter. The processor 300 may split a frame into a plurality of subframes based on the determined parameter. The counter 211 may count the number of pulse signals generated from the SPAD 212 by photons incident on the pixel 210 during the subframe period. The processor 300 may obtain an image signal based on the number of pulse signals counted during the subframe period.

In operation 730, the processor may estimate the image information of the frame based on the image signal obtained during the subframe period. The processor 300 may estimate image information of the frame based on the image signal obtained during the subframe period corresponding to the determined parameter, the frame period, and the subframe period. For example, when the periods of the subframes are equal to each other, the processor 300 may estimate image information of the frame based on the image signal obtained during the subframe period and the ratio of the subframe period to the frame period.

Because the image obtaining device 100 may estimate the image information of the frame even when the image obtaining device 100 does not perform the operation of the SPAD until a new frame begins after the one or more subframe periods have elapsed, the power consumption of the image obtaining device 100 may be greatly reduced. Hereinafter, a parameter determining method is described in detail with reference to FIG. 8.

FIG. 8 is a flowchart for describing the parameter determining method.

Referring to FIG. 8, a method of determining a parameter for splitting a frame into a plurality of subframes may be started by causing the controller 230 to set an initial parameter in operation 810.

In operation 810, the controller 230 may set the initial parameter based on the ambient illuminance of the photon counting image sensor 200. For example, the initial ambient illuminance may be obtained by an illumination sensor, but the disclosure is not limited thereto. As another example, the initial ambient illuminance may be obtained based on image information previously obtained by the image obtaining device including the photon counting image sensor 200.

In operation 820, the processor 300 may predict ambient illuminance for calibrating the subframe period based on the image information obtained during the subframe period corresponding to the set initial parameter.

In operation 830, the processor 300 may compare the predicted ambient illuminance with the preset illuminance. The preset illuminance may be a value that may be variably set by an external input. However, the disclosure is not limited thereto. As another example, the preset illuminance may be determined based on the ratio of the number of pixels 210 in which overflow has occurred to the total number of pixels 210 included in the photon counting image sensor 200.

In operation 840, when the predicted ambient illuminance is greater than the preset illuminance, the processor 300 may decrease the length of the subframe period. Even when the number of photons incident during the frame period increases, the number of photons incident during the subframe period decreases. Accordingly, the image obtaining device 100 may prevent overflow. The length of the subframe period may decrease by a first preset length of time.

In operation 850, when the predicted ambient illuminance is equal to the preset illuminance, the processor 300 may maintain the subframe period corresponding to the initial parameter during the frame period.

In operation 860, when the predicted ambient illuminance is less than the preset illuminance, the processor 300 may increase the length of the subframe period. Accordingly, as an exposure time increases, the image obtaining device 100 may implement an HDR. The length of the subframe period may increase by a second preset length of time. The first preset length of time and the second preset length of time may be set to the same value that may be arbitrarily determined, but the disclosure is not limited thereto. The first preset length of time and the second preset length of time may be variously implemented according to various embodiments of the image obtaining device 100 to which the photon counting image sensor 200 is applied.

In operation 870, the processor 300 may determine a parameter for splitting a frame into a plurality of subframes by calibrating, in operations 820 to 860, the subframe period of the initial parameter set in operation 710.

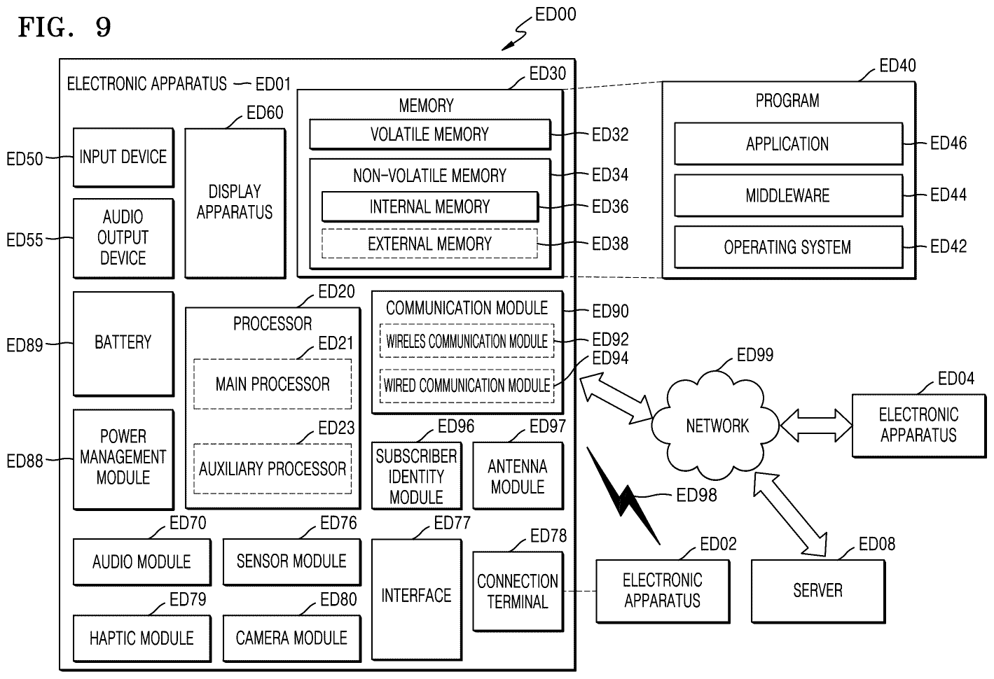

FIG. 9 is a block diagram illustrating a configuration of an electronic apparatus according to an example embodiment.

FIG. 9 is a block diagram illustrating the schematic structure of the electronic apparatus according to an example embodiment. Referring to FIG. 9, in a network environment ED00, an electronic apparatus ED01 may communicate with another electronic apparatus ED02 via a first network ED98 (e.g., a short-range wireless communication network, etc.), or may communicate with another electronic apparatus ED04 and/or a server ED08 via a second network ED99 (e.g., a long-range wireless communication network, etc.). The electronic apparatus ED01 may communicate with the electronic apparatus ED04 through the server ED08. The electronic apparatus ED01 may include a processor ED20, a memory ED30, an input device ED50, an audio output device ED55, a display device ED60, an audio module ED70, a sensor module ED76, an interface ED77, a haptic module ED79, a camera module ED80, a power management module ED88, a battery ED89, a communication module ED90, a subscriber identity module ED96, and/or an antenna module ED97. In the electronic apparatus ED01, some elements (e.g., the display device ED60, etc.) may be omitted or other elements may be added. Some elements may be implemented as a single integrated circuit. For example, the sensor module ED76 (e.g., a fingerprint sensor, an iris sensor, an illumination sensor, etc.) may be embedded in the display device ED60 (e.g., a display, etc.). In addition, when the image sensor includes a spectral function, some functions of the sensor module ED76 (e.g., a color sensor, an illumination sensor, etc.) may be implemented in the image sensor itself rather than in a separate sensor module.

The processor ED20 may execute software (e.g., a program ED40, etc.) to control one or more other elements (e.g., hardware and software elements, etc.) of the electronic apparatus ED01 connected to the processor ED20, and may perform various data processing or operations. As part of the data processing or operations, the processor ED20 may load commands and/or data received from other elements (e.g., the sensor module ED76, the communication module ED90, etc.) into a volatile memory ED32, may process the commands and/or data stored in the volatile memory ED32, and may store result data in a non-volatile memory ED34. The processor ED20 may include a main processor ED21 (e.g., a central processing unit, an application processor, etc.) and an auxiliary processor ED23 capable of operating independently of or together with the main processor ED21 (e.g., a graphics processing unit, an image signal processor, a sensor hub processor, a communication processor, etc.). The auxiliary processor ED23 may use a smaller amount of power than the main processor ED21 and may perform a specialized function.

On behalf of the main processor ED21 while the main processor ED21 is in an inactive state (e.g., a sleep state), or together with the main processor ED21 while the main processor ED21 is in an active state (e.g., an application execution state), the auxiliary processor ED23 may control the functions and/or states related to some elements of the electronic apparatus ED01 (e.g., the display device ED60, the sensor module ED76, the communication module ED90, etc.). The auxiliary processor ED23 (e.g., the image signal processor, the communication processor, etc.) may be implemented as part of other functionally related elements (e.g., the camera module ED80, the communication module ED90, etc.).

The memory ED30 may store a variety of data required by the elements of the electronic apparatus ED01 (e.g., the processor ED20, the sensor module ED76, etc.). The data may include, for example, the software (e.g., the program ED40, etc.) and input data and/or output data for commands related thereto. The memory ED30 may include the volatile memory ED32 and/or the non-volatile memory ED34. The non-volatile memory ED34 may include an internal memory ED36 fixedly mounted in the electronic apparatus ED01 and a removable external memory ED38.

The program ED40 may be stored in the memory ED30 as software, and may include an operating system ED42, a middleware ED44, and/or an application ED46.

The input device ED50 may receive, from the outside (e.g., a user, etc.) of the electronic apparatus ED01, commands and/or data to be used by the elements (e.g., the processor ED20, etc.) of the electronic apparatus ED01. The input device ED50 may include a microphone, a mouse, a keyboard, and/or a digital pen (e.g., a stylus pen, etc.).

The audio output device ED55 may output a sound signal to the outside of the electronic apparatus ED01. The audio output device ED55 may include a speaker and/or a receiver. The speaker may be used for general purposes, such as multimedia playback or recording playback, and the receiver may be used to receive an incoming call. The receiver may be integrated as part of the speaker, or may be implemented as an independent separate device.

The display device ED60 may visually provide information to the outside of the electronic apparatus ED01. The display device ED60 may include a display, a hologram device, a projector, and a control circuit for controlling the corresponding device. The display device ED60 may include a touch circuitry configured to sense a touch, and/or a sensor circuitry (e.g., a pressure sensor, etc.) configured to measure the intensity of force generated by the touch.

The audio module ED70 may convert a sound into an electrical signal or vice versa. The audio module ED70 may obtain a sound through the input device ED50, or may output a sound through the audio output device ED55 and/or a speaker and/or a headphone of another electronic apparatus (e.g., the electronic apparatus ED02) directly or wirelessly connected to the electronic apparatus ED01.

The sensor module ED76 may sense an operating state (e.g., power, temperature, etc.) of the electronic apparatus ED01 or an external environmental state (e.g., a user state, etc.), and may generate an electrical signal and/or a data value corresponding to the sensed state. The sensor module ED76 may include a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, a humidity sensor, and/or an illumination sensor.

The interface ED77 may support one or more designated protocols that may be used by the electronic apparatus ED01 so as to directly or wirelessly connect to another electronic apparatus (e.g., the electronic apparatus ED02, etc.). The interface ED77 may include a high definition multimedia interface (HDMI), a universal serial bus (USB) interface, a secure digital (SD) card interface, and/or an audio interface.

A connection terminal ED78 may include a connector through which the electronic apparatus ED01 may be physically connected to another electronic apparatus (e.g., the electronic apparatus ED02, etc.). The connection terminal ED78 may include an HDMI connector, a USB connector, an SD card connector, and/or an audio connector (e.g., a headphone connector, etc.).

The haptic module ED79 may convert an electrical signal into a mechanical stimulus (e.g., vibration, movement, etc.) or an electrical stimulus which a user may recognize through a tactile or kinesthetic sense. The haptic module ED79 may include a motor, a piezoelectric element, and/or an electrical stimulator.

The camera module ED80 may capture a still image and a moving image. The camera module ED80 may include the image obtaining device 100 described above, and may include additional lens assemblies, image signal processors, and/or flashes. The lens assemblies included in the camera module ED80 may collect light emitted from an object that is an image capture target.

The power management module ED88 may manage power to be supplied to the electronic apparatus ED01. The power management module ED88 may be implemented as part of a power management integrated circuit (PMIC).

The battery ED89 may supply power to the elements of the electronic apparatus ED01. The battery ED89 may include a non-rechargeable primary cell, a rechargeable secondary cell, and/or a fuel cell.

The communication module ED90 may establish a direct (or wired) communication channel and/or a wireless communication channel between the electronic apparatus ED01 and another electronic apparatus (e.g., the electronic apparatus ED02, the electronic apparatus ED04, the server ED08, etc.), and may support communication through the established communication channel. The communication module ED90 may include one or more communication processors that operate independently of the processor ED20 (e.g., the application processor, etc.) and may support direct communication and/or wireless communication. The communication module ED90 may include a wireless communication module ED92 (e.g., a cellular communication module, a short-range wireless communication module, a global navigation satellite system (GNSS) communication module, etc.) and/or a wired communication module ED94 (e.g., a local area network (LAN) communication module, a power line communication module, etc.). The corresponding communication module among these communication modules may communicate with another electronic apparatus via the first network ED98 (e.g., a short-range communication network such as Bluetooth, Wi-Fi Direct, or Infrared data association (IrDA)) or the second network ED99 (e.g., a long-range communication network such as a cellular network, Internet, or a computer network (LAN, WAN, etc.)). These various types of communication modules may be integrated into one element (e.g., a single chip, etc.), or may be implemented as a plurality of elements (or a plurality of chips) separate from each other. The wireless communication module ED92 may identify and authenticate the electronic apparatus ED01 within the communication network, such as the first network ED98 and/or the second network ED99, by using subscriber information (e.g., international mobile subscriber identity (IMSI), etc.) stored in the subscriber identity module ED96.

The antenna module ED97 may transmit a signal and/or power to the outside (e.g., another electronic apparatus, etc.) or receive a signal and/or power from the outside. The antenna module ED97 may include a radiator having a conductive pattern on a substrate (e.g., a printed circuit board (PCB), etc.). The antenna module ED97 may include one or more antennas. When the antenna module ED97 includes a plurality of antennas, the communication module ED90 may select an antenna suitable for the communication scheme used in the communication network, such as the first network ED98 and/or the second network ED99, among the antennas. A signal and/or power may be transmitted or received between the communication module ED90 and another electronic apparatus through the selected antenna. In addition to the antenna, other elements (e.g., a radio frequency integrated circuit (RFIC), etc.) may be included as part of the antenna module ED97.

Some elements may be connected to each other through a communication scheme between peripheral devices (e.g., bus, general purpose input and output (GPIO), serial peripheral interface (SPI), mobile industry processor interface (MIPI), etc.), and may exchange a signal (e.g., command, data, etc.) with each other.

The command or data may be transmitted or received between the electronic apparatus ED01 and the external electronic apparatus ED04 through the server ED08 connected to the second network ED99. The type of the electronic apparatuses ED02 and ED04 may be identical to or different from the type of the electronic apparatus ED01. All or part of the operations that are executed by the electronic apparatus ED01 may be executed by one or more of the electronic apparatuses ED02, ED04, and ED08. For example, when the electronic apparatus ED01 has to perform a certain function or service, the electronic apparatus ED01 may request one or more other electronic apparatuses to execute all or part of the function or service, instead of executing the function or service by itself. The one or more other electronic apparatuses receiving the request may execute an additional function or service related to the request, and may transmit an execution result to the electronic apparatus ED01. For this purpose, cloud computing, distributed computing, and/or client-server computing technologies may be used.

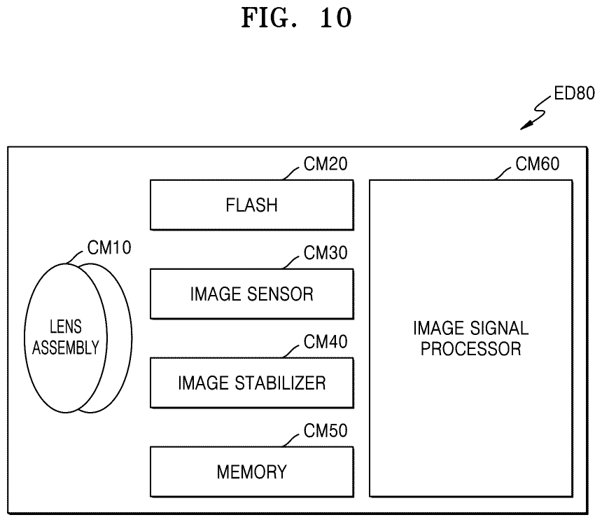

FIG. 10 is a block diagram of the camera module provided in the electronic apparatus of FIG. 9.

FIG. 10 is a block diagram illustrating the schematic configuration of the camera module ED80 provided in the electronic apparatus ED01 of FIG. 9. The camera module ED80 may include the image obtaining device 100 described above, or may have a structure modified therefrom. Referring to FIG. 10, the camera module ED80 may include a lens assembly CM10, a flash CM20, an image sensor CM30, an image stabilizer CM40, a memory CM50 (e.g., a buffer memory, etc.), and/or an image signal processor CM60.

The image sensor CM30 is the image sensor described with reference to FIGS. 1 to 5 and uses tone counting. Therefore, an HDR and a high frame rate may be achieved while minimizing the pixel size of the image sensor. A pixel of the image sensor according to an example embodiment may include an SPAD that generates pulse signals based on an electrical signal generated according to photons incident on the pixel, and may include a counter that counts the number of pulse signals, and the period of the pulse signal may be modulated according to the ambient illuminance of the image sensor. Accordingly, the image sensor CM30 may reduce the pixel size and improve the frame rate.

The lens assembly CM10 may collect light emitted from an object that is an image capture target. The camera module ED80 may include a plurality of lens assemblies CM10. In this case, the camera module ED80 may be a dual camera, a 360-degree camera, or a spherical camera. Some lens assemblies CM10 may have the same lens properties (e.g., angle of view, focal length, autofocus, F number, optical zoom, etc.), or may have different lens properties. The lens assembly CM10 may include a wide-angle lens or a telephoto lens.

The lens assembly CM10 may be configured and/or focus-controlled so that an image sensor provided in the image sensor CM30 forms an optical image of an object.

The flash CM20 may emit light used to enhance light emitted or reflected from the object. The flash CM20 may include one or more light-emitting diodes (e.g., a red-green-blue (RGB) LED, a white LED, an infrared LED, an ultraviolet LED, etc.) and/or a xenon lamp.

In response to the movement of the camera module ED80 or the electronic apparatus CM01 including the same, the image stabilizer CM40 may move one or more lenses included in the lens assembly CM10 or the image sensor in a specific direction, or may control operating characteristics of the image sensor (e.g., may adjust a read-out timing, etc.) so as to compensate a negative effect due to movement. The image stabilizer CM40 may sense the movement of the camera module ED80 or the electronic apparatus ED01 by using a gyro sensor (not shown) or an acceleration sensor (not shown) arranged inside or outside the camera module ED80. The image stabilizer CM40 may be implemented in an optical manner.

The memory CM50 may store partial or entire data of an image obtained through the image sensor for subsequent image processing. For example, when a plurality of images are obtained at a high speed, the obtained original data (e.g., Bayer-patterned data, high-resolution data, etc.) is stored in the memory CM50, and only low-resolution images are displayed. After that, the original data of the selected image (e.g., image selected by a user, etc.) may be transmitted to the image signal processor CM60. The memory CM50 may be integrated into the memory ED30 of the electronic apparatus ED01, or may be configured as a separate memory that operates independently.

The image signal processor CM60 may perform image processing on the image obtained through the image sensor CM30 or the image data stored in the memory CM50.

The image processing may include depth map generation, three-dimensional modeling, panorama generation, feature point extraction, image synthesis, and/or image compensation (e.g., noise reduction, resolution adjustment, brightness adjustment, blurring, sharpening, softening, etc.). The image signal processor CM60 may perform control (e.g., exposure time control, read-out timing control, etc.) on the elements (e.g., the image sensor CM30, etc.) included in the camera module ED80. The image processed by the image signal processor CM60 may be stored again in the memory CM50 for additional processing, or may be provided to external elements of the camera module ED80 (e.g., the memory ED30, the display device ED60, the electronic apparatus ED02, the electronic apparatus ED04, the server ED08, etc.). The image signal processor CM60 may be integrated into the processor ED20, or may be configured as a separate processor that operates independently of the processor ED20. When the image signal processor CM60 is configured as a processor separate from the processor ED20, the image processed by the image signal processor CM60 may be displayed through the display device ED60 after the processor ED20 performs additional image processing thereon.

The electronic apparatus ED01 may include a plurality of camera modules ED80 having different properties or functions from each other. In this case, one of the camera modules ED80 may be a wide-angle camera, and another thereof may be a telephoto camera. Similarly, one of the camera modules ED80 may be a front camera, and another thereof may be a rear camera.

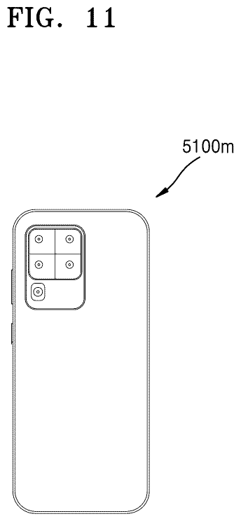

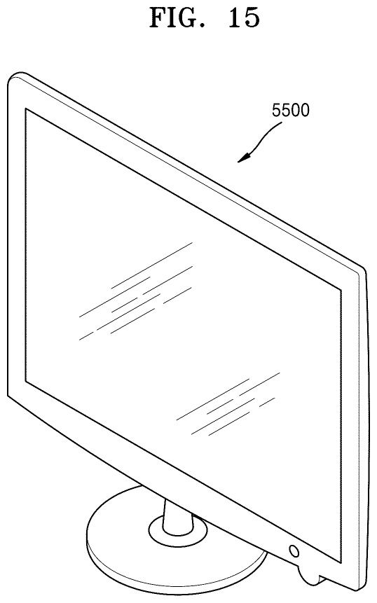

FIGS. 11 to 20 are diagrams illustrating various examples of electronic apparatuses to which an image obtaining device according to example embodiments are applied.

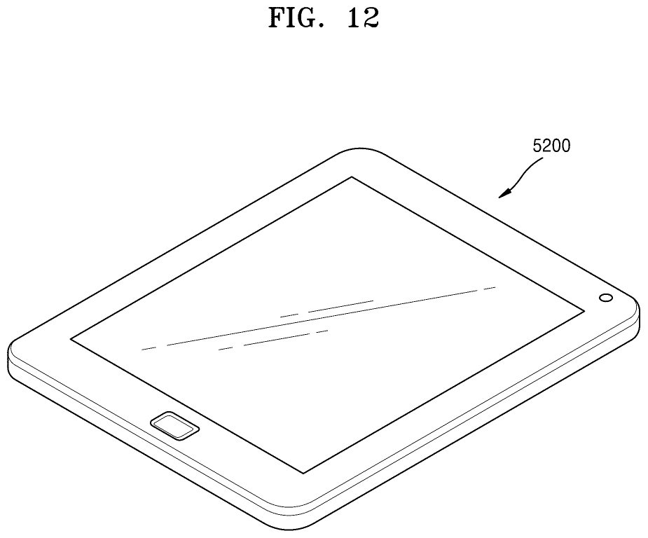

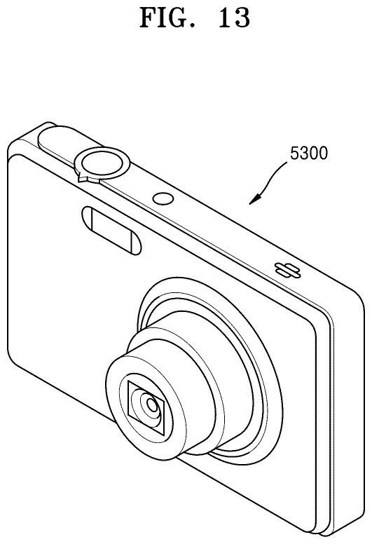

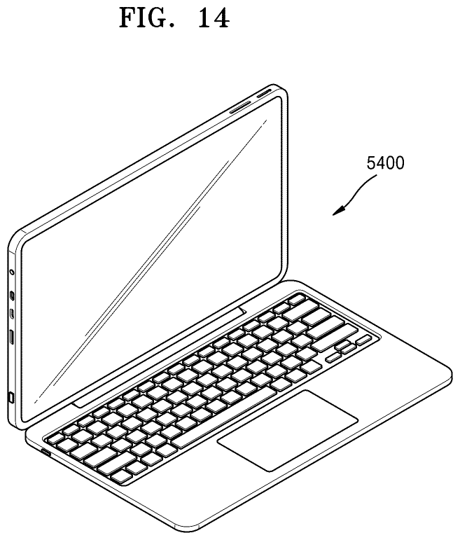

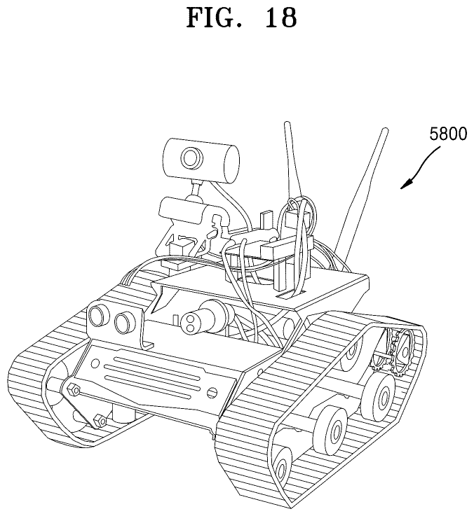

The image obtaining device according to embodiments may be applied to a mobile phone or a smartphone 5100m illustrated in FIG. 11, a tablet or a smart tablet 5200 illustrated in FIG. 12, a digital camera or a camcorder 5300 illustrated in FIG. 13, a laptop computer 5400 illustrated in FIG. 14, a television or smart television 5500 illustrated in FIG. 18, etc. For example, the smartphone 5100m or the smart tablet 5200 may include a plurality of high-resolution cameras each having a high-resolution image sensor mounted thereon. The high-resolution cameras may be used to extract depth information of objects in an image, to adjust outfocusing of an image, or to automatically identify objects in an image.

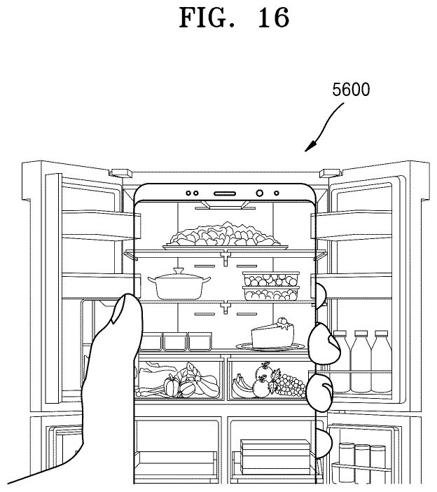

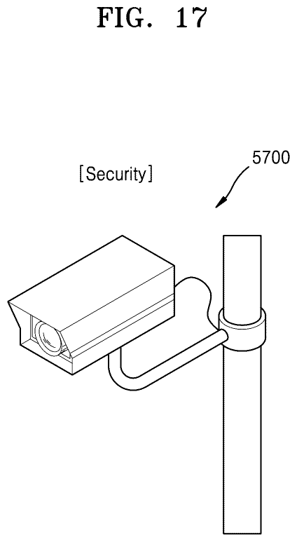

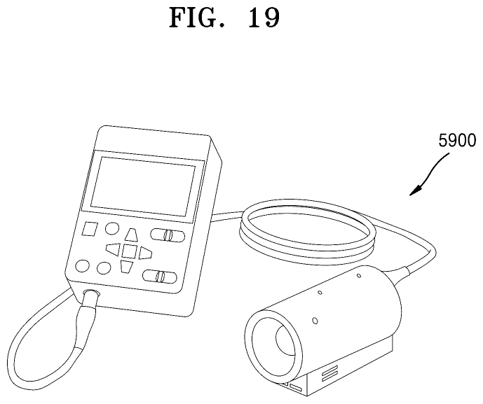

In addition, the image obtaining device 100 may be applied to a smart refrigerator 5600 illustrated in FIG. 16, a security camera 5700 illustrated in FIG. 17, a robot 5800 illustrated in FIG. 18, a medical camera 5900 illustrated in FIG. 19, etc. For example, the smart refrigerator 5600 may automatically recognize food in the refrigerator by using the image obtaining device 1000 and may notify users of the presence or absence of specific food, the type of food put into or taken out from the refrigerator through a smartphone, etc. The security camera 5700 may provide ultra-high-resolution images and may use high sensitivity to recognize objects or people in an image even in a dark environment. The robot 5800 may provide high-resolution images when deployed at disaster or industrial sites that is difficult for humans to directly access. The medical camera 5900 may provide high-resolution images for diagnosis or surgery and may dynamically adjust the field of view.

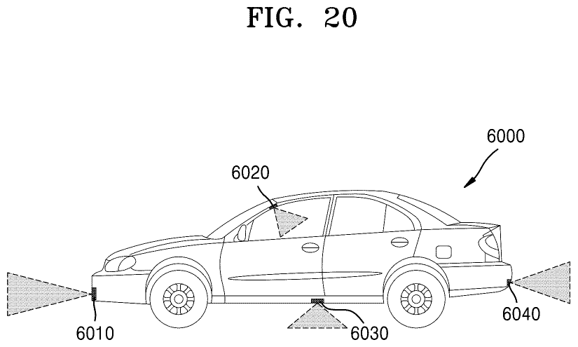

In addition, as illustrated in FIG. 20, the image obtaining device 1000 may be applied to a vehicle 6000. The vehicle 6000 may include a plurality of vehicle cameras 6010, 6020, 6030, and 6040 arranged at various positions. Each of the vehicle cameras 6010, 6020, 6030, and 6040 may include the image obtaining device according to an example embodiment. The vehicle 6000 may provide a driver with a variety of information about the interior or surroundings of the vehicle 6000 by using the vehicle cameras 6010, 6020, 6030, and 6040, and may automatically recognize objects or people in an image and provide information necessary for autonomous driving.

On the other hand, the methods described above may be recorded on a non-transitory computer-readable recording medium on which one or more programs including instructions for executing the methods are recorded. Examples of the computer-readable recording medium may include hardware devices specially configured to store and execute program commands, such as magnetic media (e.g., hard disk, floppy disk, magnetic tape, etc.), optical media (e.g., compact disc read-only memory (CD-ROM), digital versatile disc (DVD), etc.), magneto-optical media (e.g., floptical disk, etc.), read-only memory (ROM), random access memory (RAM), and flash memory. Examples of the program instructions may include not only machine language code generated by a compiler but also high-level language code that is executable using an interpreter by a computer.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and their equivalents.

What is claimed is:

1. A method of obtaining an image, the method comprising:
determining a parameter for splitting a frame into a plurality of subframes;
obtaining an image signal during at least one subframe period corresponding to the determined parameter, by using a counted number of a counter provided in a pixel of a photon counting image sensor; and
estimating image information of the frame based on the obtained image signal,
wherein the parameter comprises a frame period, a subframe period, and a threshold value of the counter.

2. The method of claim 1, wherein the determining the parameter comprises:
setting an initial parameter based on an ambient illuminance obtained by an illumination sensor or previously obtained image information; and
calibrating the initial parameter based on image information obtained during a subframe period corresponding to the initial parameter.

3. The method of claim 2, wherein the calibrating the initial parameter comprises:
obtaining image information during the subframe period corresponding to the initial parameter;
predicting an ambient illuminance of the photon counting image sensor based on the obtained image information; and
based on the predicted ambient illuminance being greater than a preset illuminance, decreasing a length of the subframe period by a first preset length of time, and based on the predicted ambient illuminance being less than the preset illuminance, increasing the length of the subframe period by a second preset length of time.

4. The method of claim 1, wherein the obtaining the image signal during the at least one subframe period comprises:
counting, by using the counter, a cumulative number of pulse signals generated by photons incident on the pixel during the at least one subframe period;
controlling an operation of a single photon avalanche diode (SPAD) provided in the pixel according to the counted cumulative number; and
obtaining an image signal based on the cumulative number counted during the operation of the SPAD.

5. The method of claim 4, wherein the controlling the operation of the SPAD comprises stopping the operation of the SPAD based on the counted cumulative number being greater than the threshold value.

6. The method of claim 1, wherein the estimating the image information of the frame comprises estimating the image information of the frame based on the image signal obtained during the at least one subframe period and a ratio of the subframe period to the frame period.

7. A device for obtaining an image, the device comprising:
a photon counting image sensor comprising:
a pixel array comprising one or more pixels; and
a counter provided in each of the one or more pixels and configured to count a number of pulse signals generated by photons incident on the one or more pixels; and
a processor configured to:
determine a parameter for splitting a frame into a plurality of subframes, wherein the parameter comprises a frame period, a subframe period, and a threshold value of the counter;
obtain an image signal during at least one subframe period corresponding to the determined parameter, by using the counted number of the counter; and
estimate image information of the frame based on the obtained image signal.

8. The device of claim 7, wherein the photon counting image sensor further comprises a controller configured to set an initial parameter based on an ambient illuminance of the photon counting image sensor or previously obtained image information, and
wherein the processor is further configured to calibrate the initial parameter based on image information obtained during a subframe period corresponding to the initial parameter.

9. The device of claim 8, wherein the processor is further configured to predict an ambient illuminance of the photon counting image sensor based on the image information obtained during the subframe period corresponding to the initial parameter, and calibrate the initial parameter based on the predicted ambient illuminance.

10. The device of claim 9, wherein the processor is further configured to decrease a length of the subframe period by a first preset length of time based on the predicted ambient illuminance being greater than a preset illuminance, and increase the length of the subframe period by a second preset length of time based on the predicted ambient illuminance being less than the preset illuminance.

11. The device of claim 9, wherein the processor is further configured to maintain the subframe period based on the predicted ambient illuminance being equal to a preset illuminance.

12. The device of claim 7, wherein the photon counting image sensor further comprises a control logic configured to output a signal for controlling an operation of a single photon avalanche diode (SPAD) provided in each of the one or more pixels, and
wherein the processor is further configured to obtain an image signal based on a cumulative number, counted by the counter, of the pulse signals generated by photons incident on the one or more pixels during the operation of the SPAD.

13. The device of claim 12, wherein the counter is further configured to transmit a threshold signal to the control logic based on the counted number being greater than the threshold value, and
wherein the control logic is further configured to output an on signal for stopping the operation of the SPAD based on the threshold signal being received at the control logic.

14. The device of claim 13, wherein the processor is further configured to transmit a reset signal to the control logic based on an elapse of the frame period, and
wherein the control logic is further configured to output an enable signal for performing the operation of the SPAD again in a next frame based on the reset signal being received at the control logic.

15. The device of claim 7, wherein the processor is further configured to estimate the image information of the frame based on the image signal obtained during the at least one subframe period and a ratio of the subframe period to the frame period.

16. A photon counting image sensor comprising:
a pixel array comprising one or more pixels;
a counter provided in each of the one or more pixels and configured to count a number of pulse signals generated by photons incident on the one or more pixels; and
a control logic configured to output a signal for controlling an operation of a single photon avalanche diode (SPAD) provided in the one or more pixels.

17. The photon counting image sensor of claim 16, wherein the counter is further configured to transmit a threshold signal to the control logic based on the counted number being greater than a threshold value of the counter, and
wherein the control logic is further configured to output an on signal for stopping the operation of the SPAD based on the threshold signal being received at the control logic.

18. The photon counting image sensor of claim 17, wherein the control logic is further configured to receive a reset signal based on an elapse of a frame period, and output an enable signal for performing the operation of the SPAD again in a next frame.

19. The photon counting image sensor of claim 16, further comprising a controller configured to set an initial parameter for splitting a frame into a plurality of subframes based on an ambient illuminance of the photon counting image sensor or previously obtained image information,
wherein the initial parameter is calibrated based on image information obtained during a subframe period corresponding to the initial parameter, and
wherein the calibrated parameter comprises a frame period, a subframe period corresponding to the calibrated parameter, and a threshold value of the counter.

20. The photon counting image sensor of claim 19, wherein the ambient illuminance of the photon counting image sensor is predicted based on the image information obtained during the subframe period corresponding to the initial parameter, and
wherein the subframe period corresponding to the calibrated parameter is obtained by calibrating the subframe period corresponding to the initial parameter based on the predicted ambient illuminance and a preset illuminance.
